(19) United States
(12) Patent Application Publication
(10) Pub. No.: US 2006/0003658 A1
(43) Pub. Date: Jan. 5, 2006

(54) Elastic clothlike meltblown materials, articles containing same, and methods of making same

(76) Inventors: Gregory K. Hall, Menasha, WI (US); Thomas Harold Roessler, Appleton, WI (US); Paul Theodore VanGompel, Hortonville, WI (US); Peiguang Zhou, Appleton, WI (US)

Correspondence Address: KIMBERLY-CLARK WORLDWIDE, INC., 401 NORTH LAKE STREET, NEENAH, WI, 54956, US

(21) Appl. No.: 10/880,889

(22) Filed: Jun. 30, 2004

(51) Int. Cl. B32B 27/12; B32B 5/26

(52) U.S. Cl. 442/329; 442/400; 442/381; 442/394

(57) ABSTRACT

A method for forming either an extensible or elastic laminate includes the steps of providing an elastic layer; and extruding at least one extensible meltblown web directly upon a first surface of the elastic layer to form an elastic layer and nonwoven laminate without the use of a separate adhesive.

### FIELD OF INVENTION

The present invention relates to elastic clothlike laminates including a clothlike meltblown layer and an additional elastic layer. In particular, the present invention relates to elastic laminate materials that can be used at least as personal care product bodyside facing liner material (or topsheets), outercovers, waist elastic materials, side panel materials, ear materials, containment flaps, leg elastics (gasketing) and hook and loop fastening materials (female attachment components).

### BACKGROUND OF THE INVENTION

Various elastic laminate composites have been formed by bonding a film layer to one or more nonwoven facing layers to form either a stretch bonded laminate, a neck bonded laminate or a neck stretch bonded laminate. Stretch bonded laminate materials offer machine direction stretch and recovery properties. Neck bonded laminates offer cross-machine direction stretch and recovery properties. Neck stretch bonded laminates offer stretch and recovery properties in both the cross-machine and machine directions. Therefore, although there are numerous methodologies to construct a biaxially extensible (and/or stretchable) film laminate, these methods typically utilize a limited number of base principles to accomplish the biaxial extensibility. It should be noted that for the purposes of this application, the term “extensible” means the ability of a material to be elongated, but not necessarily having the ability to recover or retract. The terms “stretchable” and “stretchability” shall mean the ability of a material to both elongate and recover at least partially, upon release of the biasing force stretching the material. The term stretchable shall also be used interchangeably with the term “elastic”.

The methods for making an elastic film and nonwoven material biaxially extensible/stretchable include making a nonwoven or woven facing material extensible prior to bonding it to an elastic film. Such bonding may typically be accomplished through an adhesive lamination step. Such facings may be made extensible by use processes such as aperturing, slitting, necking or creping. A combination of two or more of these methods could also be attempted by laminating a cross-machine direction extensible facing to a machine direction pre-stretched film. However, the cross-machine direction extensibility/elasticity is further reduced in the machine direction stretching process due to film shrinkage/necking in the cross-direction. Alternatively, a biaxially stretchable film may be achieved by pre-stretching an elastic film in both the machine and cross-machine directions prior to laminating the film to a non-extensible or at least partially extensible facing material. The non-extensible or partially extensible facing material provides gathers upon film contraction, which can provide room for stretch. Still further, a combination of these principles may be used to obtain biaxial extensibility.

Despite all of these methods, it has proven difficult and/or expensive to create a facing material that has biaxial extensibility or to stretch an elastic film in both the machine and cross-machine directions prior to lamination to a facing. Further, such methodologies require an extended manufacturing line with numerous process steps.

While such materials do provide levels of extensibility and/or stretchability (elasticity) in either one or multiple directions, there is still a need for film and nonwoven laminates which provide significant elasticity in two directions, such as two perpendicular directions, a cloth-like feel, and at an acceptable price point. There is also a need for efficient methods of manufacturing such materials which do not hamper the elastic performance of the materials produced, or require additional bonding or other processing steps. For instance, there is a need for elastic laminates which do not rely on adhesives to bond the laminate, since adhesives can negatively impact elasticity and material softness or “hand”. For the purposes of this application, the “hand” of a material shall mean the tactile feel.

Various thermoplastic elastomers are known for use in elastic layers, including without limitation styrenic block copolymers. These block copolymers, which are often expensive (such as the saturated styrenic block copolymers), are available from numerous polymer suppliers, such as from Kraton Polymers of Houston, Tex. and Septon Company of America, of Pasadena, Tex. Other suppliers of such polymers include Dexco Polymers of Houston, Tex., and Dynasol of Spain. As a result of their high cost, elastic laminates including styrenic block copolymers are typically the most expensive component in absorbent personal care products such as in diapers, diaper pants, adult incontinence garments, feminine hygiene products and the like.

Further, it has been found that while some of the more costly saturated styrenic block copolymers are more readily extruded through film manufacturing equipment, such as styrene-ethylene-butylene-styrene and styrene-ethylene-propylene-styrene block copolymers (available from Kraton Polymers) others suffer from reduction in polymer performance as a result of the excessive temperatures and degrading/harsh conditions of a film manufacturing line. For instance, some polymers change molecular weight as a result of the conditions in a film manufacturing line. It would therefore be desirable to use lower cost styrenic block copolymers, such as unsaturated styrenic block copolymers, that do not negatively impact end-product elastic performance, and which are not negatively affected by film manufacturing conditions. For the purposes of this application, the term “unsaturated styrenic block copolymers” shall refer to the unsaturated midblock portion of the polymer.

Important properties of elastic laminates include providing sufficient elastic tension at various degrees of elongation during use, and providing sufficient recovery upon stress relaxation (creep resistance). It is desirable to obtain such attributes from an elastic laminate material while still providing a cloth-like feel (hand)), without limiting its biaxial stretchability at comparably low cost. It is to such desires that the current invention is directed.

### SUMMARY OF THE INVENTION

The present invention is directed to methods for making an elastic laminate and laminates produced therefrom. In particular, a method for forming an elastic laminate includes the steps of providing an elastic layer; and then extruding or meltspinning at least one extensible web directly upon a first surface of the elastic layer to form an elastic layer and nonwoven laminate. In one embodiment the extensible web is elastic. In another alternative embodiment the extensible web is an extruded meltblown web. In still a further alternative embodiment the elastic layer is selected from a preformed elastic film, an in-line produced elastic film, a pre-formed elastic meltblown web or an in-line produced elastic meltblown web. In yet another alternative embodiment the elastic layer includes an elastomer selected from the group consisting of an unsaturated styrenic block copolymer, a saturated styrenic block copolymer, a polyurethane or a combination of any of such polymers wherein the polymer or polymers has a combined melt flow index greater than 10 g/10 min. In still another alternative embodiment the elastic layer includes an unsaturated styrenic block copolymer. In still another alternative embodiment the extensible meltblown web includes a single site catalyzed polyolefin. In still a further alternative embodiment the extensible meltblown layer includes a single site catalyzed polyethylene or blend having a density of less than about 0.91 g/cc. In still another alternative embodiment the extensible meltblown layer includes a single site catalyzed polyethylene or blend having a density of less than about 0.89 g/cc. In still another alternative embodiment the extensible meltblown web is a coformed web. In still another alternative embodiment, the method further includes the step of extruding at least one additional extensible meltblown web to a surface of the elastic layer that is opposite to that of the first surface. In yet another alternative embodiment the elastic layer is a film. In still another alternative embodiment the elastic layer is a multilayered film. In yet another alternative embodiment the elastic layer is a breathable film. In yet another alternative embodiment, the elastic layer is a film that is slit and/or apertured. In yet another alternative embodiment, the elastic layer is a meltblown web. In still another alternative embodiment, the method further includes the step of passing the produced laminate through a pressure and heated nip. In yet another alternative embodiment the extensible meltblown web is applied to the elastic layer in a basis weight of between about 2 and 100 gsm.

In one embodiment the elastic laminate has an ultimate stretchability of at least 50% in the machine direction and 25% in the cross-machine direction, with an ultimate tension of at least 100 g in each of the machine and cross-machine directions. In another embodiment, the elastic laminate has an ultimate stretchability of at least 100% in the machine direction and 75% in the cross-machine direction, with an ultimate tension of at least 250 g in each of the machine and cross-machine directions. In still another embodiment the elastic laminate has an ultimate stretchability of at least 200% in the machine direction and 150% in the cross-machine direction, with an ultimate tension of at least 500 g in each of the machine and cross-machine directions.

In another embodiment a method for forming an elastic laminate includes the steps of first providing an elastic layer; and then extruding at least one extensible meltblown web directly upon a first surface of the elastic layer to form an elastic layer (film or meltblown) and nonwoven (meltblown) laminate without the use of a separate adhesive. In yet another embodiment of the method, the method for forming an elastic laminate includes the steps of providing an elastic layer; extruding at least one extensible meltblown web directly upon a first surface of the elastic layer to form an elastic layer and nonwoven (meltblown) laminate and directly following lamination; passing the laminate through either a thermal, ultrasonic or pressure bonding step in order to enhance the integrity of the laminate.

### BRIEF DESCRIPTION OF THE DRAWINGS

FIGS. 1A-1E illustrate cross-sectional views of elastic laminates made in accordance with the invention, including either an elastic film layer and at least one meltblown nonwoven layer, or an elastic meltblown layer and at least one additional meltblown layer.

FIG. 2 schematically illustrates a manufacturing process for making film laminates and/or meltblown laminates in accordance with the invention.

FIG. 3 illustrates a perspective cutaway view of an exemplary personal care product incorporating elastic laminates made in accordance with the inventive process.

FIG. 4 illustrates a graph demonstrating elastic performance of the inventive elastic film/meltblown laminate material.

FIG. 5 illustrates a graph demonstrating additional elastic performance of the inventive elastic film/meltblown laminate material.

FIG. 6 illustrates a graph demonstrating elastic performance of the inventive elastic meltblown/meltblown laminate material.

FIG. 7 illustrates a graph demonstrating elastic performance of the inventive elastic meltblown/meltblown laminate material.

### Definitions

A “block copolymer” is a polymer in which dissimilar polymer segments, each including a string of similar monomer units, are connected by covalent bonds. For instance, a “SEBS” block copolymer includes a string or segment of repeating styrene units, followed by a string or segment of repeating ethylene-butylene units, followed by a second string or segment of repeating styrene units.

The term “nonwoven fabric or web” means a web having a structure of individual fibers or threads which are interlaid, but not in an identifiable manner as in a knitted or woven fabric. Nonwoven fabrics or webs have been formed from many processes such as for example, meltblowing processes, spunbonding processes, and bonded carded web processes. The basis weight of nonwoven fabrics is usually expressed in ounces of material per square yard (osy) or grams per square meter (gsm) and the fiber diameters useful are usually expressed in microns. (Note that to convert from osy to gsm, multiply osy by 33.91).

The term “microfibers” means small diameter fibers having an average diameter not greater than about 75 microns, for example, having an average diameter of from about 0.5 microns to about 50 microns, or more particularly, microfibers may have an average diameter of from about 2 microns to about 40 microns. Another frequently used expression of fiber diameter is denier, which is defined as grams per 9000 meters of a fiber and may be calculated as fiber diameter in microns squared, multiplied by the density of the polymer in grams/cc, multiplied by 0.00707. A lower denier indicates a finer fiber and a higher denier indicates a thicker or heavier fiber. For example, the diameter of a polypropylene fiber given as 15 microns may be converted to denier by squaring, multiplying the result by 0.89 g/cc and multiplying by 0.00707. Thus, a 15 micron polypropylene fiber has a denier of about 1.42 (i.e., 15²×0.89×0.00707=1.415).

The term “spunbond fibers” refers to small diameter microfibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al, each incorporated by reference herein in its entirety. Spunbond fibers are generally not tacky when they are deposited onto a collecting surface. Spunbond fibers are generally continuous and have average diameters (from a sample of at least 10) larger than 7 microns, more particularly, between about 10 and 20 microns.

The term “meltblown” means fibers/microfibers formed by extruding a molten thermoplastic material through a plurality of fine, usually circular die capillaries as molten threads or filaments into converging high velocity gas (e.g. air) streams which attenuate the filaments of molten thermoplastic material to reduce their diameter to microfiber diameter. Thereafter, the meltblown fibers are carried by the high velocity gas stream and are deposited on a collecting surface to form a web of randomly dispersed meltblown fibers. Such a process is disclosed, in various patents and publications, including NRL Report 4364, “Manufacture of Super-Fine Organic Fibers” by B. A. Wendt, E. L. Boone and D. D. Fluharty; NRL Report 5265, “An Improved Device For The Formation of Super-Fine Thermoplastic Fibers” by K. D. Lawrence, R. T. Lukas, J. A. Young; and U.S. Pat. No. 3,849,241, issued Nov. 19, 1974, to Butin, et al, which patent is incorporated by reference hereto in its entirety. Meltblown fibers are microfibers which may be continuous or discontinuous, are generally smaller than 10 microns in average diameter, and are usually tacky when deposited onto a collecting surface.

As used herein, the term “melt spinning” shall mean a process in which a fiber forming substance is melted and extruded into air or other gas, where it is cooled and solidified.

As used herein, the terms “coform” or “coformed” mean a process in which at least one meltblown diehead is arranged near a chute through which other materials are added to the web while it is forming. Such other materials may be pulp, superabsorbent particles, cellulose or staple fibers, for example. Coform processes are shown in U.S. Pat. No. 4,818,464 to Lau and U.S. Pat. No. 4,100,324 to Anderson et al., each incorporated by reference hereto in its entirety.

As used herein the term “set” refers to retained elongation in a material sample following an elongation and recovery, i.e. after the material has been stretched and allowed to relax during a cycle test. The term “permanent set” refers to the retained set after a period of time following retraction, such as after 1 minute.

As used herein, the term “ultimate stretchability” shall refer to the elongation point of a material as which the layers of a laminate separate or delaminate upon a simple constant rate of extension test such as a Stress-Strain (at 2000 g or Break) Test described herein. The “ultimate stretchability” may also refer to the failure point of the laminate material if all laminate layers break simultaneously. This point is indicated by the onset of a sharp drop in tension (such as a drop of more than five (5) percent tension over a ten (10) percent increment of elongation) and is expressed as a percent elongation.

As used herein, the term “ultimate tension” is the force in grams recorded at the ultimate stretchability elongation.

As used herein the term “thermal point bonding” involves passing a fabric or web of fibers to be bonded between a heated calender roll and an anvil roll. The calender roll is usually, though not always, patterned in some way so that the entire fabric is not bonded across its entire surface, and the anvil roll is usually flat. As a result, various patterns for calender rolls have been developed for functional as well as aesthetic reasons. One example of a pattern has points and is the Hansen Pennings or “H&P” pattern with about a 30 percent bond area with about 200 bonds/square inch as taught in U.S. Pat. No. 3,855,046 to Hansen and Pennings, incorporated herein by reference hereto in its entirety. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). The resulting pattern has a bonded area of about 29.5 percent. Another typical point bonding pattern is the expanded Hansen Pennings or “EHP” bond pattern which produces a 15 percent bond area with a square pin having a side dimension of 0.037 inches (0.94 mm), a pin spacing of 0.097 inches (2.464 mm) and a depth of 0.039 inches (0.991 mm). Another typical point bonding pattern designated “714” has square pin bonding areas wherein each pin has a side dimension of 0.023 inches, a spacing of 0.062 inches (1.575 mm) between pins, and a depth of bonding of 0.033 inches (0.838 mm). The resulting pattern has a bonded area of about 15 percent. Yet another common pattern is the C-Star pattern which has a bond area of about 16.9 percent. The C-Star pattern has a cross-directional bar or “corduroy” design interrupted by shooting stars. Other common patterns include a diamond pattern with repeating and slightly offset diamonds with about a 16 percent bond area and a wire weave pattern looking as the name suggests, e.g. like a window screen pattern having a bond area in the range of from about 15 percent to about 21 percent and about 302 bonds per square inch. Still other pattern bond rolls may be used, such as those described in the examples which follow.

Typically, the percent bonding area varies from around 10 percent to around 30 percent of the area of the fabric laminate. As is well known in the art, the spot bonding holds the laminate layers together as well as imparts integrity to each individual layer by bonding filaments and/or fibers within each layer. Alternatively, such bonding may be accomplished by compression of two materials between heated flat surfaces, such as heated flat pressure rolls (which form a nip).

As used herein, the term “ultrasonic bonding” means a process performed, for example, by passing the fabric between a sonic horn and anvil roll as illustrated in U.S. Pat. No. 4,374,888 to Bornslaeger, incorporated by reference herein in its entirety.

As used herein, the term “breathable” refers to a material which is permeable to water vapor. The water vapor transmission rate (WVTR) or moisture vapor transfer rate (MVTR) is measured in grams per square meter per 24 hours, and shall be considered equivalent indicators of breathability. The term “breathable” desirably refers to a material which is permeable to water vapor having a minimum WVTR (water vapor transmission rate) of desirably about 100 g/m²/24 hours. Even more desirably, such material demonstrates breathability greater than about 300 g/m²/24 hours. Still even more desirably, such material demonstrates breathability greater than about 1000 g/m²/24 hours.

The WVTR of a fabric, in one aspect, gives an indication of how comfortable a fabric would be to wear. WVTR is measured as indicated below. Often, personal care product applications of breathable barriers desirably have higher WVTRs and breathable barriers of the present invention can have WVTRs exceeding about 1,200 g/m²/24 hours, 1,500 g/m²/24 hours, 1,800 g/m²/24 hours or even exceeding 2,000 g/m²/24 hours.

“Neck bonding” refers to the process wherein an elastic member is bonded to a non-elastic member while only the non-elastic member is extended or necked so as to reduce its dimension in the direction orthogonal to the extension. “Neck bonded laminate” refers to a composite elastic material made according to the neck bonding process, i.e., the layers are joined together when only the non-elastic layer is in an extended condition. Such laminates usually have cross directional stretch properties. Further examples of neck-bonded laminates are such as those described in U.S. Pat. Nos. 5,226,992, 4,981,747, 4,965,122 and 5,336,545 to Morman and U.S. Pat. No. 5,514,470 to Haffner et al., each of which is incorporated by reference herein in its entirety.

“Stretch bonding” refers to a process wherein an elastic member is bonded to another member while only the elastic member is extended, such as by at least about 25 percent of its relaxed length. “Stretch bonded laminate” refers to a composite elastic material made according to the stretch bonding process, i.e., the layers are joined together when only the elastic layer is in an extended condition so that upon relaxing the layers, the nonelastic layer is gathered. Such laminates usually have machine directional stretch properties and may be subsequently stretched to the extent that the nonelastic material gathered between the bond locations allows the elastic material to elongate. One type of stretch bonded laminate is disclosed, for example, by U.S. Pat. No. 4,720,415 to Vander Wielen et al., in which multiple layers of the same polymer produced from multiple banks of extruders are used. Other composite elastic materials are disclosed in U.S. Pat. No. 4,789,699 to Kieffer et al., U.S. Pat. No. 4,781,966 to Taylor and U.S. Pat. No. 4,657,802 and 4,652,487 to Morman and U.S. Pat. No. 4,655,760 to Morman et al., as well as U.S. Pat. No. 5,385,775 to Wright, each of the foregoing being incorporated by reference herein in its entirety.

“Neck-stretch bonding” generally refers to a process wherein an elastic member is bonded to another member while the elastic member is extended such as by at least about 25 percent of its relaxed length and the other layer is a necked, non-elastic layer. “Neck-stretch bonded laminate” refers to a composite elastic material made according to the neck-stretch bonding process, i.e., the layers are joined together when both layers are in an extended condition and then allowed to relax. Such laminates usually have multi-directional stretch properties.

The terms “elastic” and “elastomeric” when referring to a fiber, film or nonwoven fabric mean a material which upon application of a biasing force, is stretchable in at least one direction by at least 50% to a stretched, biased length which is at least 50% greater than its relaxed, unstretched length, and which will recover at least 50 percent of its elongation upon release of the stretching, biasing force after about a minute (and under ambient conditions).

The term “recover” or “retract” refers to a relaxation of a stretched material upon removal of a biasing force following stretching of the material by application of the biasing force. For example, if a material having a relaxed, unbiased length of one (1) inch was elongated 50 percent by stretching to a length of one and one half (1.5) inches, the material would have a stretched length that is 50% greater than its relaxed length. If this exemplary stretched material contracted, that is recovered to a length of one and one tenth (1.1) inches after release of the biasing and stretching force, the material would have recovered 80 percent (0.4 inch) of its elongation.

The term “polymer” generally includes but is not limited to, homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the molecule. These configurations include, but are not limited to isotactic, syndiotactic and random symmetries.

The term “garment” means any type of non-medically oriented apparel which may be worn. This includes industrial or protective workwear like coveralls, labcoats, undergarments, pants, shirts, jackets, gloves, socks, and the like.

The term “infection control product” means medically oriented items such as surgical gowns and drapes, face masks, head coverings like bouffant caps, surgical caps and hoods, footwear like shoe coverings, boot covers and slippers, wound dressings, bandages, sterilization wraps, wipers, garments like lab coats, coveralls, aprons and jackets, patient bedding, stretcher and bassinet sheets, and the like.

The term “personal care product” shall be used interchangeably with “absorbent articles” and means diapers, training pants, absorbent underpants, adult incontinence products, swimwear, feminine hygiene products, and mortuary and veterinary absorbent products.

As used herein, the terms “machine direction” or MD means the direction along the length of a fabric or other web or film in the direction in which it is produced. The terms “cross-machine direction,” “cross directional,” or CD mean the direction across the width of fabric, i.e. a direction generally perpendicular to the MD.

As used herein, and in the claims, the term “comprising” is inclusive or open-ended and does not exclude additional unrecited elements, compositional components, or method steps. Accordingly, such terms are intended to be synonymous with the words “has”, “have”, “having”, “includes”, “including”, and any derivatives of these words.

Test Method Procedures:

Stress-Strain Cycle Test (2 Cycle to 100% Elongation, 3^{rd} Elongation to Break)

An elastic composite (laminate) sample of 2 inch wide and 6 inch long is placed in the clamps of a constant rate of extension (CRE) load frame, such as a SINTECH tensile tester commercially available from the MTS Systems Corporation, model Synergie 200, Eden Prairie, Minn. Starting at a 4 inch gauge length between the sample grips, the sample is elongated at 500 mm/min. (or approximately 20 inches/minute) to 100% elongation (8 in jaw-span). The cross-head returns to the original 4 inch gauge length position to complete each cycle. Two full cycles to 100% elongation are performed, followed by a third elongation to break. The data points are recorded and plotted in grams force on the Y axis and % elongation on the X axis. Percent set was determined as the percent elongation at which the specimen reaches zero load on the return portion (i.e. retraction) of the cycle. Testing was conducted at approximately 73° F. and about 50 percent relative humidity.

For percent hysteresis calculations, the data acquired was at a rate of 100 data points per cycle. The loading and unloading energy were calculated by integrating the area under the respective curves. The lower % hysteresis values correspond to better elastic efficiency of the composite measured. Percentage hysteresis was then calculated according to the following equation.
% HYSTERESIS=[(LOADING ENERGY−UNLOADING ENERGY)/LOADING ENERGY]×100
Stress-Strain Elongation (to 2000 Gram or Break) Test

An elastic composite (laminate) sample of 2 inch wide and 6 inch long is placed in the clamps of a constant rate of extension (CRE) load frame, such as a SINTECH tensile tester commercially available from the MTS Systems Corporation, model Synergie 200, Eden Prairie, Minn. Starting at a 4 inch gauge length between the sample grips (clamps), the sample is elongated at 500 mm/min. (or approximately 20 inches/minute) until 2000 g tension are reached or until breakage of material, whichever occurs first. The data points are recorded and plotted in grams force on the Y axis and % elongation on the X axis. Testing was conducted at approximately 73° F. and about 50 percent relative humidity.

It should be clear that for each run of the above tests, testing is done with the direction of testing (either the MD or CD test) as the longer 6 inch dimension in the grips. For example, if the CD direction values were to be tested, the sample was cut with 6 inches in the CD and the 6 inches were placed between the grips (to provide for the 4 inch gauge) as described.

Water Vapor Transmission Rate (WVTR)/Breathability:

A suitable technique for determining the WVTR (water vapor transmission rate) value of a film or laminate material of the invention is the test procedure standardized by INDA (Association of the Nonwoven Fabrics Industry), number IST-70.4-99, entitled “STANDARD TEST METHOD FOR WATER VAPOR TRANSMISSION RATE THROUGH NONWOVEN AND PLASTIC FILM USING A GUARD FILM AND VAPOR PRESSURE SENSOR” which is incorporated by reference herein. The INDA procedure provides for the determination of WVTR, the permeance of the film to water vapor and, for homogeneous materials, water vapor permeability coefficient.

The INDA test method is well known and will not be set forth in detail herein. However, the test procedure is summarized as follows. A dry chamber is separated from a wet chamber of known temperature and humidity by a permanent guard film and the sample material to be tested. The purpose of the guard film is to define a definite air gap and to quiet or still the air in the air gap while the air gap is characterized. The dry chamber, guard film, and the wet chamber make up a diffusion cell in which the test film is sealed. The sample holder is known as the Permatran-W Model 100K manufactured by Mocon, Inc., Minneapolis, Minn. A first test is made of the WVTR of the guard film and the air gap between an evaporator assembly that generates 100% relative humidity. Water vapor diffuses through the air gap and the guard film and then mixes with a dry gas flow which is proportional to water vapor concentration. The electrical signal is routed to a computer for processing. The computer calculates the transmission rate of the air gap and the guard film and stores the value for further use.

The transmission rate of the guard film and air gap is stored in the computer as CalC. The sample material is then sealed in the test cell. Again, water vapor diffuses through the air gap to the guard film and the test material and then mixes with a dry gas flow that sweeps the test material. Also, again, this mixture is carried to the vapor sensor. This information is used to calculate the transmission rate at which moisture is transmitted through the test material according to the equation:
TR⁻¹_{test material}=TR⁻¹_{test material, guardfilm, airgap}−TR⁻¹_{guardfilm, airgap}
Calculations:
WVTR: The calculation of the WVTR uses the formula:
   WVTR=Fpₛₐₜ(T)RH/(Apₛₐₜ(T)(1−RH))
   where:
F=The flow of water vapor in cc/min.,
pₛₐₜ(T)=The density of water in saturated air at temperature T,
RH=The relative humidity at specified locations in the cell,
A=The cross sectional area of the cell, and,
pₛₐₜ(T)=The saturation vapor pressure of water vapor at temperature T.

For the purposes of this Application, the testing temperature for the above test should be at about 37.8° C., the flow was at about 100 cc/min, and the relative humidity at about 60%. Additionally, the value for n should be equal to 6 and the number of cycles should be 3.

### DETAILED DESCRIPTION

In accordance with the invention, an elastic laminate is provided which utilizes an extensible meltblown facing layer that is desirably deposited/extruded immediately following extrusion/formation directly onto either an elastic film or an elastic meltblown layer. For the purposes of this application, the term “immediately” shall mean either that the extensible meltblown facing layer is deposited directly following melt extrusion from the meltblown die onto the surface of an elastic film or alternatively, onto the surface of an elastic meltblown layer. In such a process, the extensible meltblown facing layer is thermally bonded to the elastic film or meltblown layer on contact. Such thermal bonding may be enhanced by application of additional pressure, such as through the nip of pressured rolls. In an alternative embodiment, the extensible meltblown layer is deposited/extruded immediately following extrusion/formation directly onto an elastic spunbond or other elastic nonwoven layer.

The extensible meltblown facing layer can be made from a variety of extensible or elastic materials, such as single site catalyzed polyolefins (such as metallocene catalyzed polyethylenes and polypropylenes), high meltflow rate thermoplastic elastomers (having melt flow rates greater than about 10 g/10 min as measured using ASTM D 1238 at 200° C. and 5 Kg) such as styrene-isoprene-styrene (SIS) block copolymer, styrene-butadiene-styrene (SBS) block copolymer, styrene ethylene-propylene-styrene (SEPS) block copolymer, styrene ethylene-butylene-styrene (SEBS) block copolymer, ethylene vinyl acetate (EVA) such as those available under the trade name Elvax, of Dupont, polyamide elastomers, such as those available under the trade name PEBAX from Atofina Chemicals, Inc., of Philadelphia, Pa., and polyurethane polymers, such as those available under the trade name Elastollan, of BASF Corporation. Such polymers may be present in combination, and/or may also include processing aids, tackifiers, coloring agents, or other additives, to impart desired functionality to the extensible nonwoven facing layer surface. Such other functionality may be alcohol or water repellency, antimicrobial effect, or hydrophilicity, depending on the ultimate end use application. In one embodiment, such elastic material is a combination of polymers having a combined total melt index (melt flow index of the polymer mixture or blend) greater than about 10 g/10 min. in accordance with the above test.

In one embodiment, the extensible meltblown facing layer is comprised of a single site catalyzed polyolefin (plastomer) such as polyethylene or polypropylene. Desirably, such single site catalyzed polyolefins have densities less than about 0.91 g/cc (particularly for polyethylene materials). In an alternative embodiment, such single site catalyzed polyolefin has a density less than about 0.90 g/cc for polyethylene materials. In still another alternative embodiment, such single site catalyzed polyolefin has a density less than about 0.89 g/cc for polyethylene materials. Such single site catalyzed polyolefins are available from numerous polymer suppliers as metallocene-catalyzed polyolefins or constrained geometry polyolefins. A particulary desirable material is a single site catalyzed ethylene octene copolymer. Such single site catalyzed polymers are available from the Dow Chemical Co. under the trade name AFFINITY, or from ExxonMobil Corporation under the trade name EXACT. For example, such polyethylene polymers may be illustrated by AFFINITY EG 8185, having a density of 0.886 g/cc and Exact 0230 having a density of 0.902 g/cc, and both having a melt index of 30 g/10 minutes (ASTM D 1238 190° C. and 2.16 Kg).

Desirably, in one embodiment, such extensible meltblown facing layer is applied directly to the surface of an elastic film immediately following film formation. In a second alternative embodiment, such extensible meltblown facing layer is applied to a preformed elastic film provided from a supply roll. In still a further alternative embodiment, such extensible meltblown facing layer is applied directly to the surface of an elastic meltblown layer immediately following the elastic meltblown layer formation. In still a further alternative embodiment, the extensible meltblown facing layer is applied to an elastic meltblown layer that has been supplied in a preformed fashion. In still a further alternative embodiment of the invention, the extensible meltblown facing layer is applied to an elastic meltblown layer in such a fashion that there is mixing of the fibers of the two layers. For example, in such an embodiment, the meltblown die heads of the two webs are configured such that there is some overlap between meltblown fiber streams. In still a further alternative embodiment of the invention, the extensible meltblown layer is applied to an elastic coform/meltblown layer. In still a further alternative embodiment of the invention, an elastic meltblown layer is applied to an extensible coform/meltblown layer. In yet a further alternative embodiment, if two meltblown layers are laminated thereto, or a coform and meltblown layer are laminated to each other, the meltblown material in each layer is of a different polymeric formulation. In yet another alternative embodiment of the invention, the extensible meltblown layer is also elastic.

In yet still another alternative embodiment of the invention, one extensible meltblown layer is applied to each side of either an elastic film or elastic meltblown layer. In still a further alternative embodiment of the invention, more than one extensible meltblown layer is applied to only one side of an elastic film or elastic meltblown layer.

In one specific embodiment, such meltblown facing layer is applied/extruded onto the surface of the film at a basis weight of between about 2 gsm and 100 gsm. In a second embodiment, such meltblown facing layer is applied at a basis weight of between about 5 and 50 gsm. In still a further alternative embodiment, such meltblown layer is applied at a basis weight of between about 10 and 30 gsm. In one embodiment, the elastic film has a basis weight of between about 5 and 150 gsm. In a second embodiment, the elastic film has a basis weight of between about 10 and 80 gsm. In a further alternative embodiment, such elastic film has a basis weight of between about 20 and 40 gsm.

If two layers of extensible meltblown are applied to an elastic film (one to each opposing side of the film), then in one embodiment it is desirable that each side include a meltblown having a basis weight of between about 2 and 50 gsm. In an alternative, each side includes a meltblown facing of a basis weight of between about 5 and 40 gsm. In still a further alternative embodiment, each side includes a meltblown facing of a basis weight of between about 10 and 30 gsm.

In the case of an extensible meltblown web laminated to an elastic meltblown web, it is desirable that the extensible meltblown web be between about 2 and 100 gsm. In an alternative embodiment, it is desirable that such extensible meltblown web be between about 5 and 50 gsm. In still a further alternative embodiment, it is desirable that such extensible meltblown web be between about 10 and 30 gsm. In one embodiment, it is desirable that the elastic meltblown web have a basis weight of between about 2 and 100 gsm. In an alternative embodiment, it is desirable that the elastic meltblown web have a basis weight of between about 5 and 50 gsm. In still a further alternative embodiment, it is desirable that such elastic meltblown web have a basis weight of between about 10 and 30 gsm. As with the previous film embodiment descriptions, if an elastic meltblown includes an extensible meltblown on each opposing side (one on each side), then in one embodiment it is desirable to have each extensible meltblown web having a basis weight of between about 2 and 50 gsm. In a second alternative embodiment, it is desirable that each extensible meltblown web (on each side) have a basis weight of between about 5 and 40 gsm. In still another alternative embodiment, it is desirable that each side have an extensible meltblown web having a basis weight of between about 5 and 30 gsm.

If the elastic layer is comprised of a coformed meltblown elastic material, it is desirable in one embodiment for the coform/elastic layer to have a basis weight of between about 2 and 100 gsm. In an alternative embodiment, it is desirable that the coform elastic layer have a basis weight of between about 5 and 50 gsm. In still another alternative embodiment, it is desirable that the coform elastic layer have a basis weight of between about 10 and 30 gsm. The single extensible meltblown layer in such an embodiment desirably has a basis weight of between about 2 and 100 gsm. In an alternative embodiment, the extensible meltblown layer in such an embodiment has a basis weight of between about 5 and 50 gsm. In still a further alternative embodiment, the extensible meltblown layer has a basis weight of between about 10 and 30 gsm. If two extensible meltblown layers are present (one on each side of the elastic coformed layer), then in one embodiment, each of the extensible meltblown layers has a basis weight of between about 2 and 50 gsm. In a second embodiment, each of the extensible meltblown layers has a basis weight of between about 5 and 40 gsm. In a further alternative embodiment, each of the extensible meltblown layers has a basis weight of between about 5 and 30 gsm.

As previously stated, such extensible meltblown layers may be applied to one or both opposing surfaces of an elastic film, elastic meltblown or elastic coformed material. The meltblown layers may be of the same or different composition. Furthermore, additional extensible meltblown layers may be applied to a single side of an elastic layer.

Desirably in one embodiment, the ratio of extensible meltblown in weight to elastic meltblown (in an extensible meltblown/elastic meltblown laminate) is between about 1:4 and 2:1. For an extensible meltblown layer/elastic film layer laminate a desirable ratio of layers by weight is between about 1:20 to 1:1.

As previously indicated, the meltblown is desirably applied to the surface of an elastic film or meltblown layer. While numerous polymers may serve as the base polymer for such elastic films or elastic meltblown layers (such as styrenic block copolymers and polyurethanes), saturated block copolymers such as SEBS and SEPS (available under the KRATON G designation from Kraton Polymers) may be particularly desirable. Other less costly unsaturated styrenic block copolymers may also be desirable. Such polymers include SIS triblock copolymers, such as those available from Dexco under the VECTOR designations. Additionally, blends of such polymers may be utilized to provide varying degrees of desired functionality. In one embodiment, such polymers are present in a combination with the combination having a combined total meltflow index (melt flow index of the polymer mixture or blend) greater than about 10 g/10 min. in accordance with the above described test (200° C. at 5 kg) for such elastomers. Further, multiple layered films may also be utilized to impart additional functionality to the laminate. In such a fashion, the film may include a relatively thicker core layer (compared to the skin layers) and one or more relatively thinner skin layers. Such films may be processed using either cast or blown film technology. If such film layer is a multilayered film layer, in one embodiment, the core layer occupies between about 80 and 98 weight percent of the film, or alternatively between about 90 and 95 weight percent of the film, and at least one skin layer occupies between about 20 and 2 weight percent of the film, or alternatively between about 10 and 5 weight percent of the film. If such film layer is a multilayered film layer, in another embodiment, the core layer occupies between about 80 and 98 volumer percent of the film, or alternatively between about 90 and 95 volumer percent of the film. In such an embodiment, at least one skin layer is present and occupies between about 20 and 2 volumer percent of the film, or alternatively between about 10 and 5 volumer percent of the film. In one embodiment, the elastic film includes a core layer and a skin layer on each side of the core layer. In such an embodiment skins are desirably present in an amount between about 4-10 weight percent each.

Such blended/layered films are described for example in U.S. patent application Ser. No. 10/749,681 titled Improved Thermal Stabilization and Processing Behavior of Block Copolymer Compositions by Blending, Applications Thereof, and Methods of Making Same filed Dec. 31, 2003, assigned to the same Assignee, and which is incorporated herein by reference in its entirety.

Desirably, the melblown facing layer(s) are extruded at a first temperature and then actually deposited on the film at a lower temperature that is either below or close to the melting point/softening temperature of the elastic film layer or any skin layers of the film layer. The meltblown fiber temperature should be close to or below the melting point/softening temperature of the film by adjusting the processing conditions such as die distance, air temperature or wire speed (which affects dwell time). The base film polymers may also be blended with processing aids, tackifiers, coloring agents, fillers to impart breathability, and additives such as those previously described, to impart other functionality.

In still a further alternative embodiment, two or more extensible meltblown webs (of different composition) which are extruded from two meltblown banks can be merged and applied directly to one side of an elastic film. In still a further alternative embodiment, a coformed meltblown web is applied to one or more surfaces of an elastic film. In still a further alternative embodiment, at least one meltblown web is applied to one side of an elastic film and at least one coformed meltblown web is applied to the other opposing surface of the elastic film.

As an example, in one embodiment, one meltblown layer or meltblown portion of a coformed web could be made of a polymer such as single site catalyzed polyethylene or polypropylene (or any of the other meltblown polymers described above), while the other meltblown web or coformed meltblown portion could be of an SIS or SBS, or other elastomeric material previously described.

It has been found that extensible or elastic meltblown or meltspun webs applied directly to the surface of an elastic film or meltblown layer, offer the advantages of being capable of being applied at a lower basis weight than traditional facings (which are often spunbond materials applied from supply rolls only via adhesive or pattern bonded processes), such as facings that are necked and/or creped. Further, by applying the meltblown or meltspun facing layer(s) directly to at least one surface of the film immediately following the meltblown or meltspun web formation, the need for adhesive bonding is eliminated. Such reduction in extraneous material (adhesive) in the laminate enhances the extensibility of the final laminate at reduced costs. Further, it has been found that there is no need to utilize more costly elastic meltblown, spunbond or bicomponent facing materials, such as those that rely on saturated SEBS or SEPS styrenic block copolymers, or crimped materials. Desirably, the meltblown facing layer imparts attributes such as softness, durability, coloring, hook engagement (for hook attachment functionality) antiblocking attributes to assist in roll wind up, should the produced laminate need to be stored for later use, or other such desired functionality.

Further, it has been found that the elimination of one or more extraneous bonding steps reduces the complexity of a laminate manufacturing process. It can also lead to improved consistency and evenness of the film surface pattern and maintenance of the elasticity of the elastic film or elastic meltblown in multiple directions, while still providing for a cloth-like facing that demonstrates good hand. Such materials exhibit elastic recovery while also demonstrating low set.

It should be recognized that a separate thermal bonding step in any of the above materials/methods is optional, as is in-line elastic film or elastic meltblown layer extrusion. It has been found that production of a meltblown web directly on an underlying substrate (film or meltblown web) produces a material with sufficient integrity, without the need for a separate thermal bonding step. However, a separate thermal/pressure nip may also be utilized if desired. For example, embossing drums/nips may be utilized in a meltblown and film laminate manufacturing arrangement.

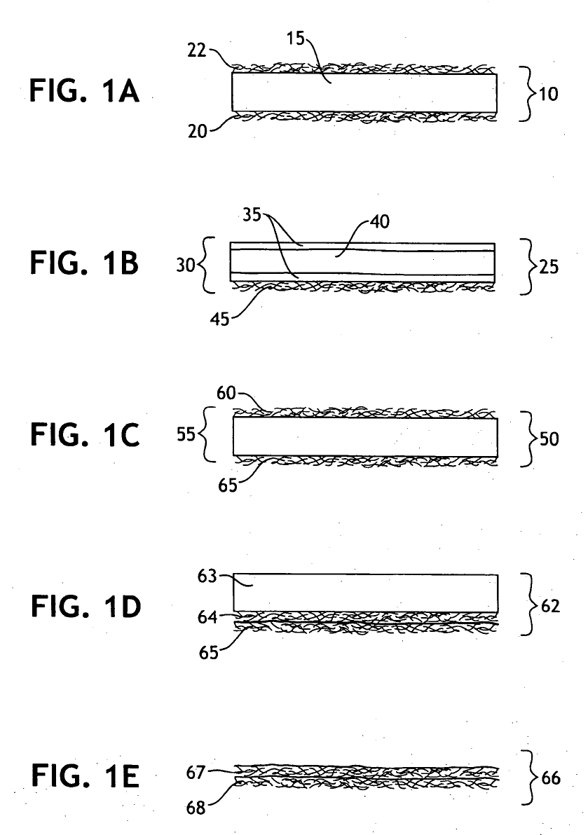

FIGS. 1A-1E illustrate cross-sectional views of laminates made in accordance with the invention, including a film layer and at least one extensible meltblown or coformed nonwoven layer, or alternatively an elastic meltblown layer and at least one extensible meltblown or coformed layer. In particular, as can be seen in FIG. 1A, an elastic film laminate 10 includes a monolayer elastic film 15 and two layers of extensible meltblown material 20 and 22 that have been deposited directly onto the untensioned or relaxed film, shortly following web extrusion/formation, and desirably, shortly following film formation. As can be seen in FIG. 1B, an elastic film laminate is shown 25 which includes a multilayered film 30 having a core layer 40 and two skin layers 35. The multilayered elastic film has been coextruded and an extensible meltblown layer 45 has been directly deposited onto one of the skin layers 35. As can be seen in FIG. 1C, an elastic film laminate 50 includes an elastic film layer and a first extensible meltblown layer 60 deposited on one side of the elastic film layer, and a second either extensible meltblown layer or coformed layer 65, deposited onto a second side of the elastic film layer, opposite to that of the first meltblown layer 60. In FIG. 1D, an elastic laminate 62 is illustrated, with an elastic film 63, an extensible melblown 64 and a coformed/meltblown layer 65. In FIG. 1E, an elastic meltblown laminate is illustrated 66, including an elastic meltblown layer 67 and an extensible meltblown layer 68.

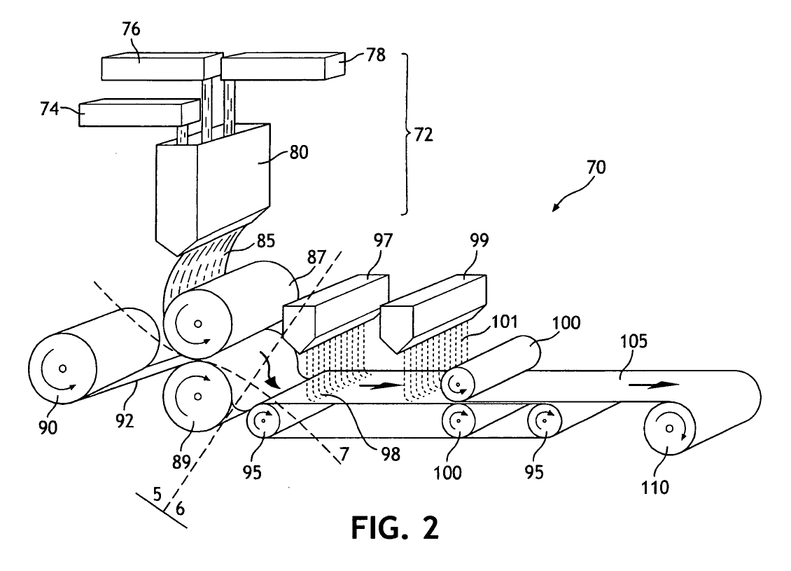

A process 70 for producing an elastic laminate 105 in accordance with the invention is illustrated in FIG. 2. The process is broken into three portions/configurations for ease of reference. If the elastic laminate is of an elastic meltblown/extensible meltblown configuration, then the process would initiate at the meltblown extrusion banks 97 and 99. If the elastic laminate is of an in-line elastic film/extensible meltblown construction, then the process would be initiated using the film forming equipment 72. If the elastic laminate is based on a pre-formed elastic film, then the laminate would receive the film component from a preformed film supply roll 90. It should be recognized that the extensible meltblown or meltspun layer may in fact be elastic as well.

In particular, in one embodiment, an elastic film 85 is first made through an extrusion process (cast or blown, but shown as cast). Desirably the film is made through a casting process 72, in which one or more polymer hoppers 74, 76, and 78 filled with polymer(s), feed a film forming die 80. If the film is to be a multi-layered film, such as including a core layer and one or more skin layers, there would by necessity be multiple extruder arrangements to provide for the coextrusion of the film. Such polymer hoppers may also include filler if the film is meant to be breathable, or other desirable additives. While not shown, the extruders include rotating screws for blending/melting the polymer(s). Desirably, the film is extruded at temperatures between about 350-450° F., or alternatively between about 400-450° F. In one embodiment skins have a softening temperature of between about 350 and 420° F. The film 85 is extruded from the film die 80, and deposited onto one or more chill rolls 87 and 89. The temperature of the chill rolls is desirably between about 5 and 20° C., or alternatively between about 5 and 10° C. If the film is meant to be breathable via pores caused by filler, then the film would be stretched prior to proceeding further through the process. If the polymer is inherently breathable, or not desirably breathable, then stretching would not be necessary. If used, such stretching could be accomplished by a machine direction orienter, as is well known. If the film is preformed and supplied from an off-line production step, such film may be introduced into the film forming nip between the rolls 87 and 89, from unwinder 90. In this instance, film forming equipment 72 need not be present in the process at all. Following film casting, the film 85 is directed onto a continuous belt or path 95 where it proceeds for further processing. At least one meltblowing, coforming, or meltspinning die 97 deposits a web of extensible meltblown polymer 98 directly onto the moving film. Optionally, a second bank of meltblowing equipment 99 is present in the process for forming a second web 101 onto the first web 98, or alternatively, to the film. The temperature of the extruded meltblown materials is desirably in one embodiment between about 350-400° F. and, certainly below the melting/softening temperature of the elastic film or film skin at the point of contact, or alternatively, the first meltblown layer, when contacted by a second or subsequent meltblown layer or coform layer. If the extruded meltblown was at the melting/softening temperature of the elastic film or meltblown at the point of contact, rupture could occur. The forming distance of the extensible meltblown above the elastic film or meltblown, is desirably between about 12-15 inches. Air pressure on the extensible meltblown banks is desirably between about 25 and 40 psi. Alternatively, air pressure is about 30 psi.

At the point that the web(s) is deposited directly upon the film or other meltblown layer, an integrated elastic laminate is produced. However, if desired, the web and film may then optionally pass through a nip of heated/pressure rolls 100 (embossing rolls) where they also would emerge as a unified web/elastic film laminate 105. If an embossing roll or pressure roll arrangement is used following extrusion of the extensible meltblown layer onto the elastic layer, such rolls could be varied in topography, from flat to patterned. The web/elastic film laminate may be wound on a winder roll 110, or may alternatively be further processed. For example, if the elastic film/extensible meltblown laminate is meant to serve as a liner, the film may pass through a slitting or perforating step so as to create macroscopic holes within its structure. These holes would be in sharp contrast to the microscopic pores that would be produced in the film by stretching a film with filler.

If the elastic laminate is an elastic meltblown layer with an extensible meltblown layer, then the film forming portion of the process 5 would be unnecessary and only the melblown portion 6 of the process would be utilized. Optionally, if the meltblown portion of the process is utilized, a vacuum source (not illustrated) may be provided beneath the forming wire/belt so as to assist in the adherence of the meltblown web onto the forming surface. As with the film, the meltblown laminate may itself be further processed such as by slitting or perforation steps. Desirably, the extrusion temperature of the meltblown banks would be similar and between about 400 and 550° F. If the extensible meltblown is a polyethylene, it would be desirable to have the extrusion temperature set between about 350 and 450° F. In an alternative embodiment, a carrier sheet may also be used on the forming wire to assist in movement of the meltblown web(s). Still in a further alternative embodiment, a blended polyethylene may be used as the extensible meltblown web to assist in removal of the web from the forming wire.

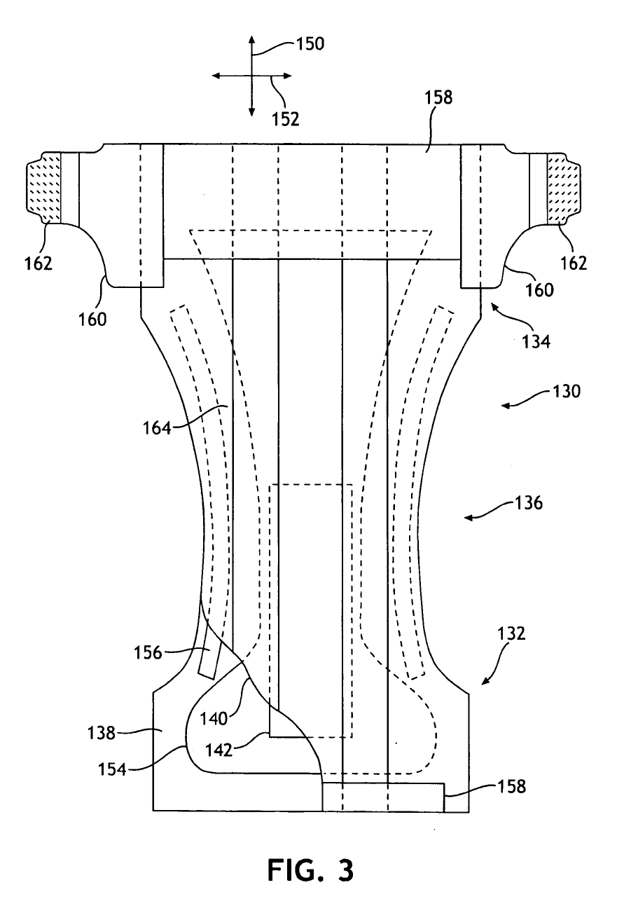

The produced meltblown elastic laminates can then be incorporated into a variety of absorbent articles, and other consumer oriented products, such as garments, personal care products, infection control products and wipes, such as wet or moistened wipes. For the purposes of example only, and not designed to be limiting, a personal care product is shown in FIG. 3, incorporating laminates of the invention. In particular, a diaper is illustrated in FIG. 3.

The produced meltblown elastic laminate material may be useful in providing elastic waist, gasketing (such as leg elastics), stretchable ear, side panel, stretchable outer cover, containment flap, stretchable liner, and hook and loop material applications. FIG. 3 is presented to illustrate such various components of a diaper, that may take advantage of such materials. With specific reference to FIG. 3, the disposable diaper 130 generally defines a front waist section 132, a rear waist section 134, and an intermediate section 136 which interconnects the front and rear waist sections. The front and rear waist sections 132 and 134 include the general portions of the diaper which are constructed to extend substantially over the wearer's front and rear abdominal regions, respectively, during use. The intermediate section 136 of the diaper includes the general portion of the diaper that is constructed to extend through the wearer's crotch region between the legs. Thus, the intermediate section 136 is an area where repeated liquid surges typically occur in the diaper.

The diaper 130 includes, without limitation, an outer cover, or backsheet 138, a liquid permeable bodyside liner, or topsheet, 140 positioned in facing relation with the backsheet 138, and an absorbent core body, or liquid retention structure, 154, such as an absorbent pad, which is located between the backsheet 138 and the topsheet 140. The backsheet 138 defines a length, or longitudinal direction 150, and a width, or lateral direction 152 which, in the illustrated embodiment, coincide with the length and width of the diaper 130. The liquid retention structure 154 generally has a length and width that are less than the length and width of the backsheet 138, respectively. Thus, marginal portions of the diaper 130, such as marginal sections of the backsheet 138, may extend past the terminal edges of the liquid retention structure 154. In the illustrated embodiment, for example, the backsheet 138 extends outwardly beyond the terminal marginal edges of the liquid retention structure 154 to form side margins and end margins of the diaper 130. The topsheet 140 is generally coextensive with the backsheet 138 but may optionally cover an area which is larger or smaller than the area of the backsheet 138, as desired.

To provide improved fit and to help reduce leakage of body exudates from the diaper 130, the diaper side margins and end margins may be elasticized with suitable elastic members, as further explained below. For example, as representatively illustrated in FIG. 3, the diaper 130 may include leg elastics 156 which are constructed to operably tension the side margins of the diaper 130 to provide elasticized leg bands which can closely fit around the legs of the wearer to reduce leakage (gasketing) and provide improved comfort and appearance. Waist elastics 158 are employed to elasticize the end margins of the diaper 130 to provide elasticized waistbands. The waist elastics 158 are configured to provide a resilient, comfortably close fit around the waist of the wearer.

The elastic film laminates and elastic meltblown laminates of the invention are suitable for use as the leg elastics 156 and waist elastics 158. Exemplary of such materials are portions of the elastomeric laminate material which are adhered to the backsheet, such that elastic constrictive forces are imparted to the backsheet 138.

As is known, fastening means, such as hook and loop fasteners, may be employed to secure the diaper 130 on a wearer. Alternatively, other fastening means, such as buttons, pins, snaps, adhesive tape fasteners, cohesives, fabric-and-loop fasteners, or the like, may be employed. The inventive material may be used, as fastening material, such as hook and loop loop-like materials. In the illustrated embodiment, the diaper 130 includes a pair of side panels 160 (or ears) to which the fasteners 162, indicated as the hook portion of a hook and loop fastener, are attached. Generally, the side panels 160 are attached to the side edges of the diaper 130 in one of the waist sections 132, 134 and extend laterally outward therefrom. The side panels 160 may also be elasticized or otherwise rendered elastomeric by use of the inventive film laminate. Examples of absorbent articles that include elasticized side panels and selectively configured fastener tabs are described in PCT Patent Application No. WO 95/16425 to Roessler; U.S. Pat. No. 5,399,219 to Roessler et al.; U.S. Pat. No. 5,540,796 to Fries; and U.S. Pat. No. 5,595,618 to Fries each of which is hereby incorporated by reference in its entirety.

The diaper 130 may also include a surge management layer 142, located between the topsheet 140 and the liquid retention structure, to rapidly accept fluid exudates and distribute the fluid exudates to the liquid retention structure 154 within the diaper 130. The diaper 130 may further include a ventilation layer (not illustrated), also called a spacer, or spacer layer, located between the liquid retention structure 154 and the backsheet 138, to insulate the backsheet 138 from the liquid retention structure 154 to reduce the dampness of the garment at the exterior surface of a breathable outer cover, or backsheet, 138. Examples of suitable surge management layers 142 are described in U.S. Pat. No. 5,486,166 to Bishop and U.S. Pat. No. 5,490,846 to Ellis.

As representatively illustrated in FIG. 3, the disposable diaper 130 may also include a pair of containment flaps 164 which are configured to provide a barrier to the lateral flow of body exudates. The containment flaps 164 may be located along the laterally opposed side edges of the diaper 130 adjacent the side edges of the liquid retention structure 154. Each containment flap 164 typically defines an unattached edge which is configured to maintain an upright, perpendicular configuration in at least the intermediate section 136 of the diaper 130, to form a seal against the wearer's body. The containment flaps 164 may extend longitudinally along the entire length of the liquid retention structure 154 or may only extend partially along the length of the liquid retention structure. When the containment flaps 164 are shorter in length than the liquid retention structure 154, the containment flaps 164 can be selectively positioned anywhere along the side edges of the diaper 130 in the intermediate section 136. The construction of such containment flaps 164 are generally well known to those skilled in the art. For example, suitable constructions and arrangements for containment flaps 164 are described in U.S. Pat. No. 4,704,116 to K. Enloe, incorporated by reference herein in its entirety. The material of the present invention may also serve as the base material for such containment flaps.

The diaper 130 may be of various suitable shapes. For example, the diaper may have an overall rectangular shape, T-shape or an approximately hour-glass shape. In the shown embodiment, the diaper 130 has a generally I-shape. Other suitable components which may be incorporated on absorbent articles of the present invention may include waist flaps and the like which are generally known to those skilled in the art. Examples of diaper configurations suitable for use in connection with the instant invention which may include other components suitable for use on diapers are described in U.S. Pat. No. 4,798,603 to Meyer et al.; U.S. Pat. No. 5,176,668 to Bernardin; U.S. Pat. No. 5,176,672 to Bruemmer et al.; U.S. Pat. No. 5,192,606 to Proxmire et al. and U.S. Pat. No. 5,509,915 to Hanson et al. each of which is hereby incorporated by reference herein in its entirety.

The various components of the diaper 130 are assembled together employing various types of suitable attachment means, such as adhesive, ultrasonic bonds, thermal bonds or combinations thereof. In the shown embodiment, for example, the topsheet 140 and backsheet 138 may be assembled to each other and to the liquid retention structure 154 with lines of adhesive, such as a hot melt, pressure-sensitive adhesive. Similarly, other diaper components, such as the elastic members 156 and 158, fastening members 162, and surge layer 142 may be assembled into the article by employing the above-identified attachment mechanisms. The inventive laminates of the present invention may be utilized for many of the above described materials where elastic performance (stretch and recovery) or hook attachment benefits are desired.

The inventive materials and methods of making them are exemplified by the following examples. As with the Figures, the examples are not meant to be limiting.

### EXAMPLES

The inventive materials and methods of making them are exemplified by the following examples. As with the Figures, the examples are not meant to be limiting.

### Example 1

A three layered elastic film (of a core with two opposing skin layers on each side of the core) was made from styrene-isoprene-styrene (SIS) block copolymers through a multi-layer cast extrusion process. The opaque film that was produced had a measured basis weight of approximately 1.77 osy (60 gsm). The elongation of the film until failure was between 600-800 percent. The three layered elastic film composition was based on a dry blend core layer of 62 percent VECTOR 4111, 26 percent VECTOR 4411, 8 percent ELVAX 240 (Ethylene vinyl acetate (EVA)), and 4 percent (50 percent titanium dioxide in polyethylene). The core comprised 92 percent of the film by weight. The skin layers were composed of 100 percent (20 percent diatomaceous earth in AFFINITY PT 1450 Polyethylene (PE)) comprising 8 percent of the film by weight. The film was formed and rolled for storage. VECTOR designation SIS polymers are available from Dexco Polymers. EVA polymers are available from DuPont. Examples of such EVA polymers include ELVAX 240, ELVAX 350, and ELVAX 3174.

At a later date, between approximately 1.30-1.45 osy (44-49 gsm) of EXACT 0230 (Metallocene catalyzed ethylene octene copolymer from ExxonMobil) was meltblown directly onto the surface of the elastic film (skin layer) over a moving wire (belt) at about 5 feet per minute. Other single-site catalyzed polymers are available from Dow Chemical Company under the AFFINITY designation.

The meltblown extruder had a melt, die and hose temperature of approximately 385° F. with a single screw speed of 27 rpm. The air temperature was about 500° F. and the air pressure was about 30 psi. The distance of the meltblown die to the film was about 15 inches. The distance of the die above the forming wire can range from about 10 to 18 inches. Although not needed for bonding, (as prior bench-produced samples indicated), the meltblown elastic film laminate was nipped and thermally bonded on a patterned drum pressure nip roll also at 5 fpm with no stretch. A dot bond pattern was used on one of the metal rolls with the other metal roll being smooth. The dot pattern consisted of 1 mm diameter circles with 5 mm spacing in a staggered arrangement with a 2 mm gap between rows. The level of bonding was about ten (10) percent. The height of the dots was about 1 mm. The heating recirculator was filled with oil for the bonding drum and had a set point temperature of about 130° C. The combined elastic film and meltblown web passed through a thermal pressured nip roller at between about 100-120° C., which resulted in a cloth-like elastic film laminate. The produced cloth-like elastic film laminate, having a final basis weight measured between about 3.0-3.2 osy (104-109 gsm) could be stretched up to 300 percent or more in both the machine and cross-machine directions, without delamination or damage to either the meltblown or elastic film layer.

### Example 2

A meltblown/meltblown nonwoven elastic laminate was made from styrene-ethylene-butylene-styrene (SEBS) block copolymer and ethylene octene copolymer through a two bank meltblown extrusion process. A single screw extruder was used to process all polymers. From a first meltblown bank, an approximate basis weight of 0.43 osy (14.7 gsm) of Kraton G2755 polymer (SEBS with tackifiers) was meltblown onto a forming wire (belt) at about 14 fpm. The first meltblown extruder had a melt, die and hose temperature of between about 392-400° F. and air temperature of about 460° F. (35 psi both sides), with a single screw speed of 26.5 rpm. From a second meltblown bank, an approximate basis weight of 0.22 osy (7.3 gsm) of EXACT 0230 was meltblown directly onto the surface of the elastic meltblown web on the moving wire (belt). The second meltblown extruder had a melt, die and hose temperature of about 385° F. and air temperature of about 425° F. (22 psi both sides), with a single screw speed of 30 rpm. The height of the meltblown dies above the meltblown layer (forming wire) was about 15 inches. No additional bonding was used to form the meltblown elastic nonwoven laminate. The produced cloth-like elastic nonwoven laminate, having a final measured basis weight of about 0.65 osy (22 gsm), could be stretched up to 200 percent or more in both the machine and cross-machine directions, without delamination or damage to either of the meltblown layers.

### Example 3

A meltblown/meltblown nonwoven elastic laminate was made from SEBS block copolymer and ethylene octene copolymer through a two bank meltblown extrusion process. A single screw extruder was used to process all polymers. From a first meltblown bank, an approximate basis weight of 0.93 osy (34.7 gsm) of Kraton G2755 polymer (SEBS with tackifiers) was meltblown onto a forming wire (belt) at about 7 fpm. The first meltblown extruder had a melt, die and hose temperature of about 392-400° F. and air temperature of about 460° F. (35 psi both sides), with a single screw speed of about 26.5 rpm. From a second meltblown bank, an approximate basis weight of 0.47 osy (17.3 gsm) of Exact 0230 was meltblown directly onto the surface of the elastic meltblown web on the moving wire (belt). The second meltblown extruder had a melt, die and hose temperature of about 385° F. and air temperature of about 425° F. (22 psi both sides), with a single screw speed of about 30 rpm. No additional bonding was used to form the meltblown elastic nonwoven laminate. The distance of the meltblown banks above the forming wire was about 15 inches. The produced cloth-like elastic nonwoven laminate, having a final measured basis weight of about 1.40 osy (52 gsm) could be stretched up to 200 percent or more in both the machine and cross-machine directions, without delamination or damage to either of the meltblown layers.

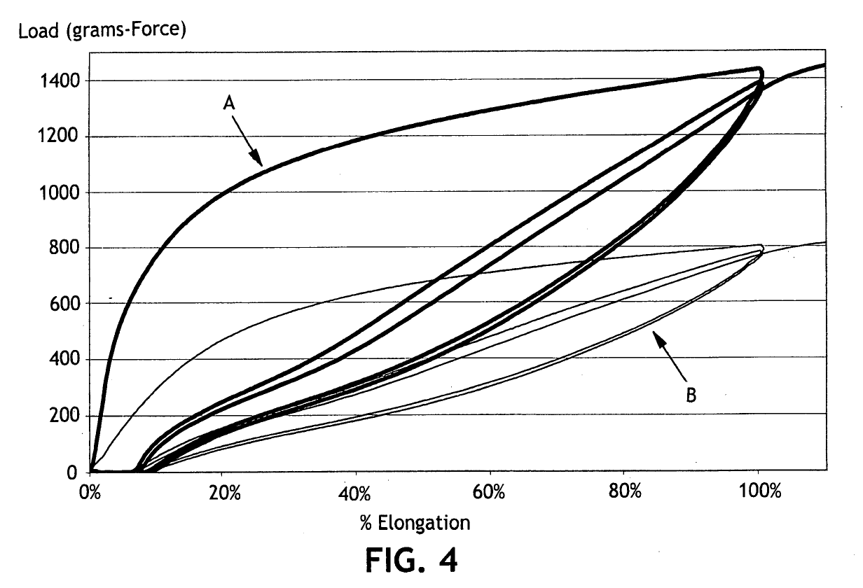

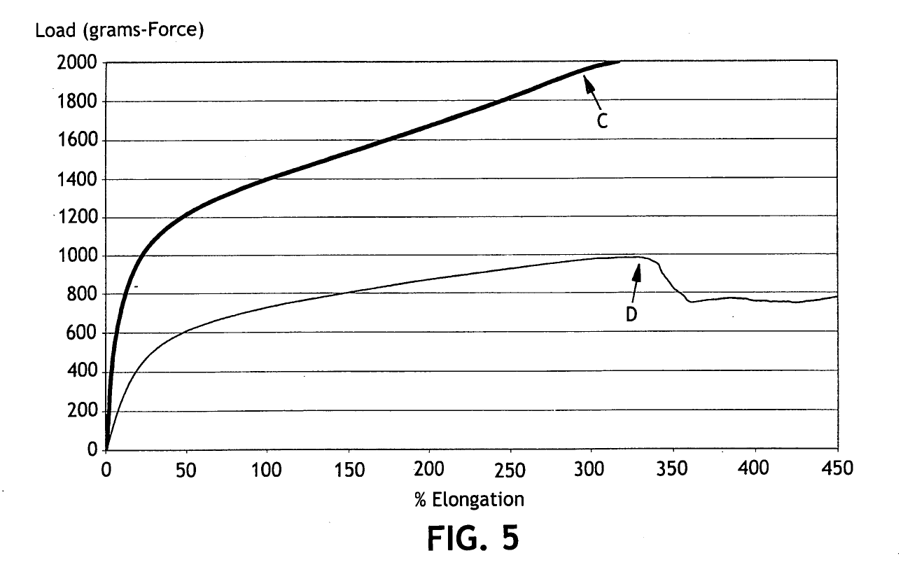

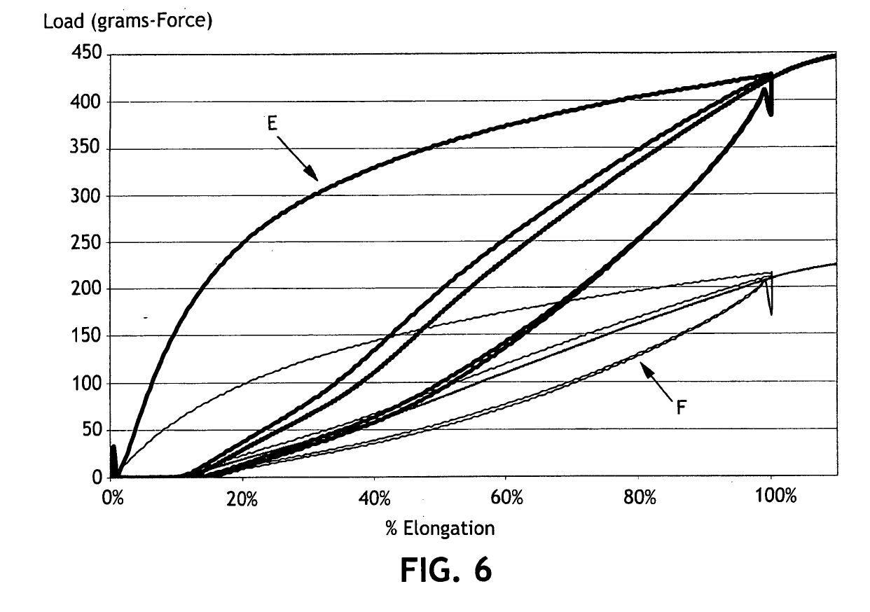

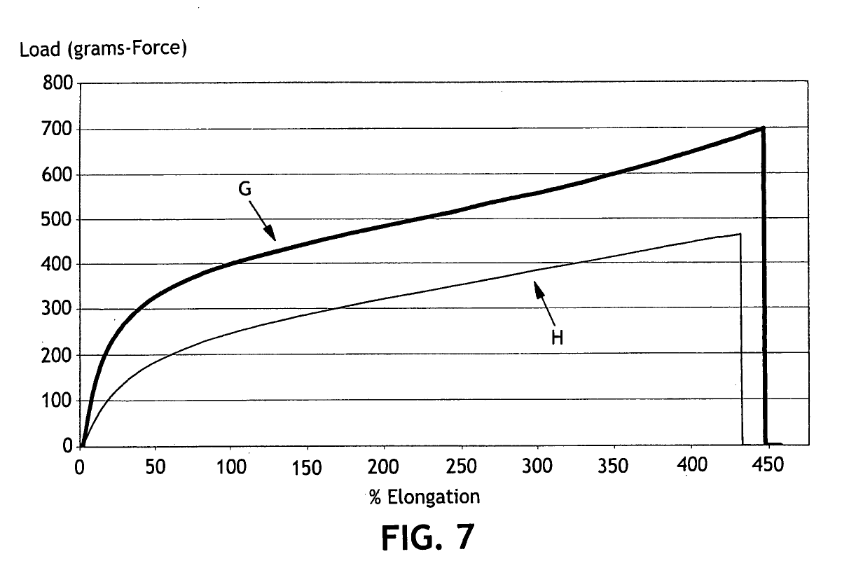

The elastic properties in both the machine and cross-machine directions of the produced film and meltblown nonwoven laminate are illustrated in FIGS. 4 and 5, and meltblown/meltblown nonwoven laminates are illustrated in FIGS. 6 and 7. From these Figures, it can be seen that elastic performance is not sacrificed in multiple directions with the application of an extensible meltblown layer directly onto an underlying elastic layer. In particular, as can be seen in FIG. 4, a stress-strain cycle test (as described previously) was run on the elastic film/meltblown laminate. In particular, the graph shows the results of a stress-stain cycle test of a cloth-like elastic film (60 gsm SIS film and approximately 50 gsm meltblown of Exact 0230. The machine direction stretch values are shown in FIG. 4 as “A”. The cross-machine stretch values are shown in FIG. 4 as “B”. FIG. 5 shows a stress-strain elongation (to 2000 g or break) test on a cloth-like elastic film (60 gsm SIS film and approximately 50 gsm meltblown Exact 0230). The machine direction stretch values are shown in FIG. 5 as “C”. The cross-machine stretch values are shown in FIG. 5 as “D”. FIG. 6 shows a stess-strain cycle test of a meltblown/meltblown web laminate (meltblown G2755/meltblown Exact 0230) at 1.4 osy. The machine direction stretch values are shown in FIG. 6 as “E”. The cross-machine direction stretch values are shown in FIG. 6 as “F”. FIG. 7 shows a stress-strain elongation (to 2000 g or break) test of a meltblown/meltblown web (meltblown G2755/meltblown Exact 0230) at 1.4 osy. The machine direction stretch values are shown in FIG. 7 as “G”. The cross-machine direction stretch values are shown in FIG. 7 as “H”.

The laminate demonstrated machine direction stretch properties of 1430 grams at 100% elongation (1^{st} Cycle), 383 grams at 50% retraction (after 2^{nd} cycle) and 9% set (after 2^{nd} cycle) and cross-machine direction stretch properties of 800 grams at 100% elongation (1^{st} Cycle), 235 grams at 50% retraction (after 2^{nd} cycle) and 8% set (after 2^{nd} cycle). As can be seen in FIG. 5, a stress-strain elongation to 2000 g or break test was conducted in accordance with the previously described procedures. The laminate demonstrated machine direction stretch and cross-machine direction tension and ultimate stretch of 2000 g at 317% and 958 g at 340% respectively. Additionally, as can be seen in FIG. 6, a stress-strain cycle test (as described previously) was run on the elastic meltblown/meltblown laminate. The laminate demonstrated machine direction stretch properties of 423 grams at 100% elongation (1^{st} Cycle), 91 grams at 50% retraction (after 2^{nd} cycle) and 14% set (after 2^{nd} cycle) and cross-machine direction stretch properties of 216 grams at 100% elongation (1^{st} Cycle), 53 grams at 50% retraction (after 2^{nd} cycle) and 12% set (after 2^{nd} cycle). As can be seen in FIG. 7, a stress-strain elongation to 2000 g or break test was conducted in accordance with the previously described procedures. The laminate demonstrated machine direction tension (load in grams-force) and ultimate stretch (percent elongation) and cross-machine direction tension and ultimate stretch of 700 g at 447% and 464 g at 432% respectively.

In alternative embodiments of the inventive material, produced by the inventive methods, the elastic laminate has an ultimate stretchability of at least 50% in the machine direction and 25% in the cross-machine direction, with an ultimate tension of at least 100 g in each of the machine and cross-machine directions. In still a further alternate embodiment of the material, the elastic laminate has an ultimate stretchability of at least 100% in the machine direction and 75% in the cross-machine direction, with an ultimate tension of at least 250 g in each of the machine and cross-machine directions. In still a further alternate embodiment of the inventive material, produced by the inventive method, the elastic laminate has an ultimate stretchability of at least 200% in the machine direction and 150% in the cross-machine direction, with an ultimate tension of at least 500 g in each of the machine and cross-machine directions.

It therefore can be seen that such processes produce effective multidirection stretchable materials without risk of delamination or failure. Such materials can be produced cost effectively and without the necessity for additional bonding steps.

While the embodiments of the invention disclosed herein are presently preferred, various modifications and improvements can be made without departing from the spirit and scope of the invention. The scope of the invention is indicated by the appended claims, and all changes that fall within the meaning and range of equivalents are intended to be embraced therein.

What is claimed is:

1. A method for forming an elastic laminate comprising the steps of:
a) providing an elastic layer;
b) extruding or meltspinning at least one extensible web directly upon a first surface of the elastic layer to form an elastic layer and nonwoven laminate.

2. The method of claim 1 wherein said extensible web is elastic.

3. The method of claim 1 wherein said extensible web is an extruded meltblown web.

4. The method of claim 1, wherein the elastic layer is selected from a preformed elastic film, an in-line produced elastic film, a pre-formed elastic meltblown web or an in-line produced elastic meltblown web.

5. The method of claim 1, wherein said elastic layer comprises an elastomer selected from the group consisting of an unsaturated styrenic block copolymer, a saturated styrenic block copolymer, a polyurethane or a combination of any of such polymers wherein the polymer or polymers has a combined melt flow index greater than 10 g/10 min.

6. The method of claim 1, wherein said elastic layer comprises an unsaturated styrenic block copolymer.

7. The method of claim 1, wherein said extensible meltblown web comprises a single site catalyzed polyolefin.

8. The method of claim 7, wherein said extensible meltblown layer comprises a single site catalyzed polyethylene or blend having a density of less than about 0.91 g/cc.

9. The method of claim 7, wherein said extensible meltblown layer comprises a single site catalyzed polyethylene or blend having a density of less than about 0.89 g/cc.

10. The method of claim 3, wherein said extensible meltblown web is a coformed web.

11. The method of claim 3, further including the step of extruding at least one additional extensible meltblown web to a surface of the elastic layer that is opposite to that of the first surface.

12. The method of claim 1, wherein said elastic layer is a film.

13. The method of claim 12, wherein said film is a multilayered film.

14. The method of claim 12, wherein said film is breathable.

15. The method of claim 12, wherein said film is slit and/or apertured.

16. The method of claim 1, wherein said elastic layer is a meltblown web.

17. The method of claim 1, further including the step of passing the produced laminate through a pressure and heated nip.

18. The method of claim 3 wherein said extensible meltblown web is applied to said elastic layer in a basis weight of between about 2 and 100 gsm.

19. The method of claim 1 wherein said elastic laminate has an ultimate stretchability of at least 50% in the machine direction and 25% in the cross-machine direction, with an ultimate tension of at least 100 g in each of the machine and cross-machine directions.

20. The method of claim 1 wherein said elastic laminate has an ultimate stretchability of at least 100% in the machine direction and 75% in the cross-machine direction, with an ultimate tension of at least 250 g in each of the machine and cross-machine directions.

21. The method of claim 1 wherein said elastic laminate has an ultimate stretchability of at least 200% in the machine direction and 150% in the cross-machine direction, with an ultimate tension of at least 500 g in each of the machine and cross-machine directions.

22. A laminate material produced by the method of claim 1.

23. A personal care product comprising the material of claim 22.

24. A loop material produced by the laminate material of claim 22 that can be engaged with a hook type mechanical fastener element.

25. A method for forming an elastic laminate comprising the steps of:
a) providing an elastic layer;
b) extruding at least one extensible meltblown web directly upon a first surface of the elastic layer to form an elastic layer and nonwoven laminate without the use of a separate adhesive.

26. A laminate produced by the method of claim 25.

27. A method for forming an elastic laminate comprising the steps of:
a) providing an elastic layer;
b) extruding at least one extensible meltblown web directly upon a first surface of the elastic layer to form an elastic layer and nonwoven laminate and directly following lamination;
c) passing the laminate through either a thermal, ultrasonic or pressure bonding step in order to enhance the integrity of the laminate.
